(19) United States
(12) Patent Application Publication
(10) Pub. No.: US 2025/0133433 A1
(43) Pub. Date: Apr. 24, 2025

(54) INDICATION OF SIMULTANEOUS UPLINK TRANSMISSION FOR MULTIPLE TRANSMIT RECEIVE POINTS

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/836,181

(22) PCT Filed: Apr. 21, 2022
(86) PCT No.: PCT/CN2022/088138

§ 371 Date: Aug. 6, 2024

(51) Int. Cl. H04W 24/10; H04B 7/0408

(52) U.S. Cl. CPC H04W 24/10; H04B 7/0408

(57) ABSTRACT

Various aspects of the present disclosure generally relate to wireless communication. In some aspects, a user equipment (UE) may receive. from a network entity, a group-based beam report configuration. The UE may transmit, to the network entity, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE. Numerous other aspects are described.

### FIELD OF THE DISCLOSURE

Aspects of the present disclosure generally relate to wireless communication and to techniques and apparatuses for indication of simultaneous uplink transmission for multiple transmit receive points.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive, from a network entity, a group-based beam report configuration. The one or more processors may be configured to transmit, to the network entity, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE.

Some aspects described herein relate to a UE for wireless communication. The user equipment may include a memory and one or more processors coupled to the memory. The one or more processors may be configured to receive, from a network entity, a group-based beam report configuration that indicates a beam group type for a group-based beam report. The one or more processors may be configured to transmit, to the network entity, the group-based beam report based at least in part on the beam group type indicated by the group-based beam report configuration.

Some aspects described herein relate to a network entity for wireless communication. The network entity may include a memory and one or more processors coupled to the memory. The one or more processors may be configured to transmit, to a UE, a group-based beam report configuration. The one or more processors may be configured to receive, from the UE, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE.

Some aspects described herein relate to a network entity for wireless communication. The network entity may include a memory and one or more processors coupled to the memory. The one or more processors may be configured to transmit, to a UE, a group-based beam report configuration that indicates a beam group type for a group-based beam report. The one or more processors may be configured to receive, from the UE, the group-based beam report based at least in part on the beam group type indicated by the group-based beam report configuration.

Some aspects described herein relate to a method of wireless communication performed by a UE. The method may include receiving, from a network entity, a group-based beam report configuration. The method may include transmitting, to the network entity, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE.

Some aspects described herein relate to a method of wireless communication performed by a UE. The method may include receiving, from a network entity, a group-based beam report configuration that indicates a beam group type for a group-based beam report. The method may include transmitting, to the network entity, the group-based beam report based at least in part on the beam group type indicated by the group-based beam report configuration.

Some aspects described herein relate to a method of wireless communication performed by a network entity. The method may include transmitting, to a UE, a group-based beam report configuration. The method may include receiving, from the UE, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE.

Some aspects described herein relate to a method of wireless communication performed by a network entity. The method may include transmitting, to a UE, a group-based beam report configuration that indicates a beam group type for a group-based beam report. The method may include receiving, from the UE, the group-based beam report based at least in part on the beam group type indicated by the group-based beam report configuration.

Some aspects described herein relate to a non-transitory computer-readable medium that stores a set of instructions for wireless communication by a UE. The set of instructions, when executed by one or more processors of the UE, may cause the UE to receive, from a network entity, a group-based beam report configuration. The set of instructions, when executed by one or more processors of the UE, may cause the UE to transmit, to the network entity, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE.

Some aspects described herein relate to a non-transitory computer-readable medium that stores a set of instructions for wireless communication by a UE. The set of instructions, when executed by one or more processors of the UE, may cause the UE to receive, from a network entity, a group-based beam report configuration that indicates a beam group type for a group-based beam report. The set of instructions, when executed by one or more processors of the UE, may cause the UE to transmit, to the network entity, the group-based beam report based at least in part on the beam group type indicated by the group-based beam report configuration.

Some aspects described herein relate to a non-transitory computer-readable medium that stores a set of instructions for wireless communication by a network entity. The set of instructions, when executed by one or more processors of the network entity, may cause the network entity to transmit, to a UE, a group-based beam report configuration. The set of instructions, when executed by one or more processors of the network entity, may cause the network entity to receive, from the UE, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE.

Some aspects described herein relate to a non-transitory computer-readable medium that stores a set of instructions for wireless communication by a network entity. The set of instructions, when executed by one or more processors of the network entity, may cause the network entity to transmit, to a UE, a group-based beam report configuration that indicates a beam group type for a group-based beam report. The set of instructions, when executed by one or more processors of the network entity, may cause the network entity to receive, from the UE, the group-based beam report based at least in part on the beam group type indicated by the group-based beam report configuration.

Some aspects described herein relate to an apparatus for wireless communication. The apparatus may include means for receiving, from a network entity, a group-based beam report configuration. The apparatus may include means for transmitting, to the network entity, a group-based beam report indicating a beam group, including a first beam and a second beam, associated with simultaneous downlink transmissions, wherein the group-based beam report indicates whether simultaneous uplink transmission using the first beam and the second beam of the beam group is supported.

Some aspects described herein relate to an apparatus for wireless communication. The apparatus may include means for receiving, from a network entity, a group-based beam report configuration that indicates a beam group type for a group-based beam report. The apparatus may include means for transmitting, to the network entity, the group-based beam report based at least in part on the beam group type indicated by the group-based beam report configuration.

Some aspects described herein relate to an apparatus for wireless communication. The apparatus may include means for transmitting, to a UE, a group-based beam report configuration. The apparatus may include means for receiving, from the UE, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE.

Some aspects described herein relate to an apparatus for wireless communication. The apparatus may include means for transmitting, to a UE, a group-based beam report configuration that indicates a beam group type for a group-based beam report. The apparatus may include means for receiving, from the UE, the group- based beam report based at least in part on the beam group type indicated by the group-based beam report configuration.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example logical architecture of a distributed radio access network (RAN), in accordance with the present disclosure.

FIG. 5 is a diagram illustrating an example of multiple transmit receive point (TRP) communication, in accordance with the present disclosure.

FIG. 6 is a diagram illustrating examples of uplink transmissions for single TRP communication and multiple TRP communication, in accordance with the present disclosure.

FIGS. 7-8 are diagrams illustrating examples associated with indication of simultaneous uplink transmission for multiple TRPs, in accordance with the present disclosure.

FIGS. 9-12 are diagrams illustrating example processes associated with simultaneous uplink transmission for multiple TRPs, in accordance with the present disclosure.

FIGS. 13-14 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

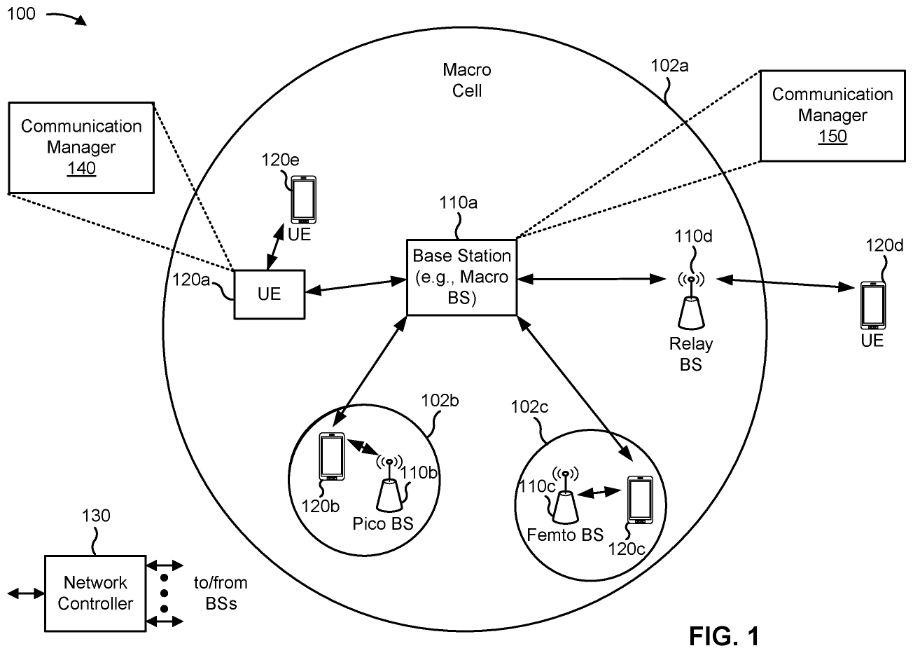

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHZ-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FRI, FR2, FR3, FR4, FR4-a, FR4-1, and/or FR5) may be modified, and techniques described herein are applicable to those modified frequency ranges.

In some aspects, the UE 120 may include a communication manager 140. In some aspects, as described in more detail elsewhere herein, the communication manager 140 may receive, from a network entity, a group-based beam report configuration; and transmit, to the network entity, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE. Additionally, or alternatively, the communication manager 140 may perform one or more other operations described herein.

In some aspects, as described in more detail elsewhere herein, the communication manager 140 may receive, from a network entity, a group-based beam report configuration that indicates a beam group type for a group-based beam report; and transmit, to the network entity, the group-based beam report based at least in part on the beam group type indicated by the group-based beam report configuration. Additionally, or alternatively, the communication manager 140 may perform one or more other operations described herein.

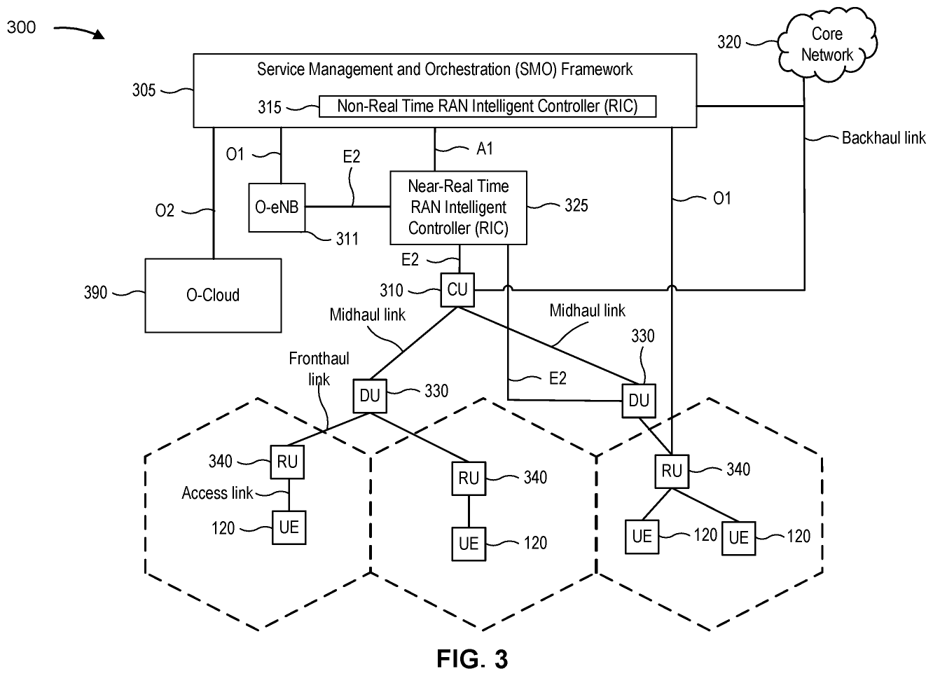

In some aspects, a network entity (e.g., a base station 110 or one or more components described in connection with FIG. 3) may include a communication manager 150. In some aspects, as described in more detail elsewhere herein, the communication manager 150 may transmit, to a UE, a group-based beam report configuration; and receive, from the UE, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE. Additionally, or alternatively, the communication manager 150 may perform one or more other operations described herein.

In some aspects, as described in more detail elsewhere herein, the communication manager 150 may transmit, to a UE, a group-based beam report configuration that indicates a beam group type for a group-based beam report; and receive, from the UE, the group-based beam report based at least in part on the beam group type indicated by the group-based beam report configuration. Additionally, or alternatively, the communication manager 150 may perform one or more other operations described herein.

As indicated above, FIG. 1 is provided as an example. Other examples may differ from what is described with regard to FIG. 1.

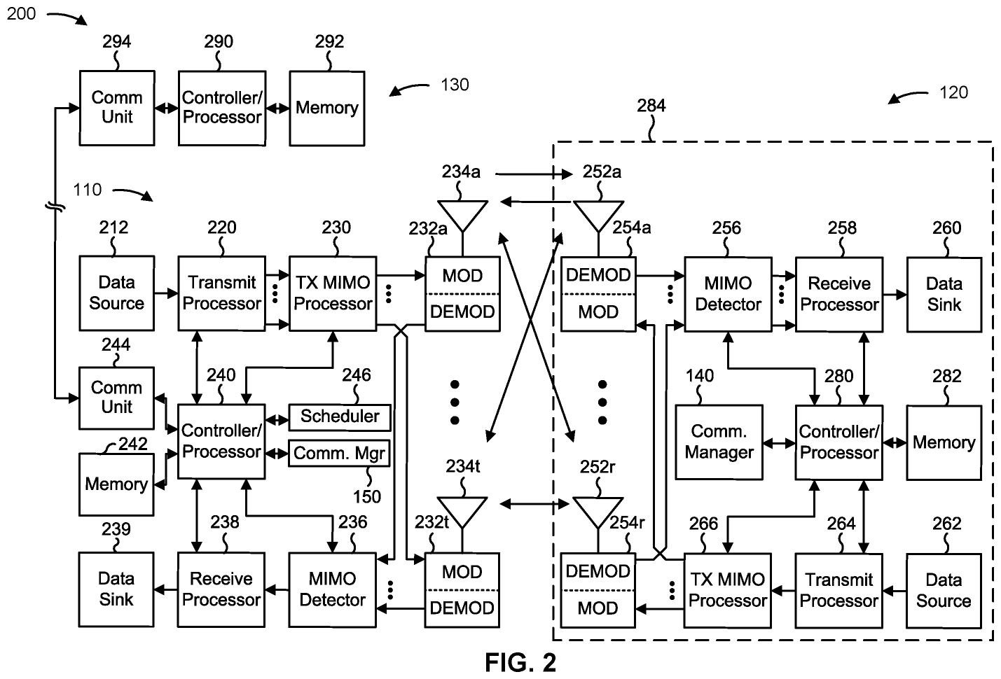

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

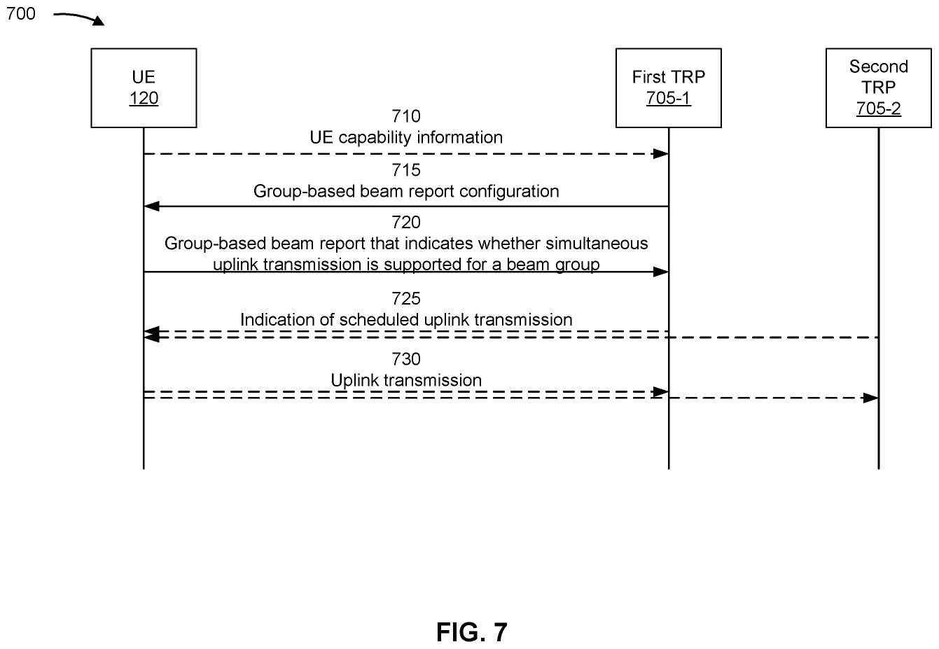

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-14).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-14).

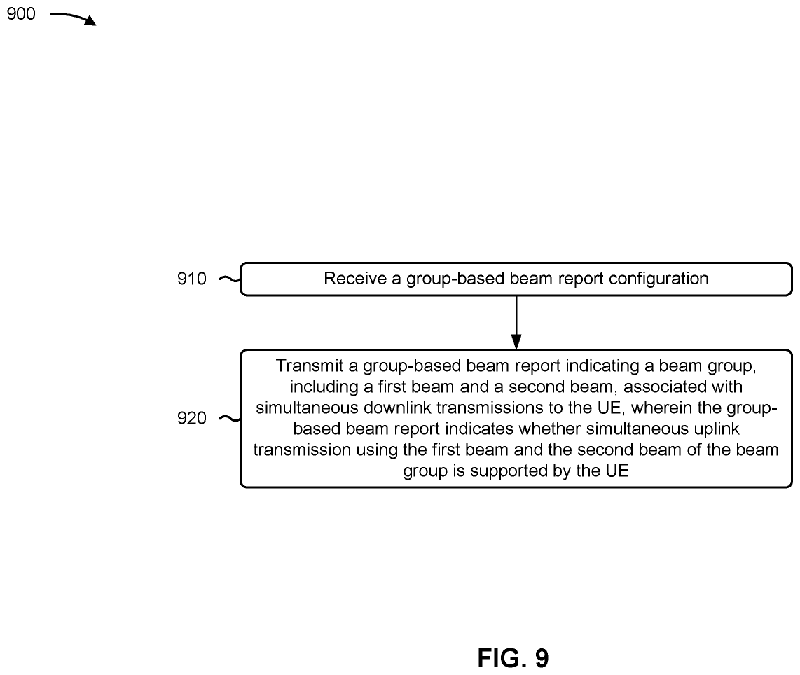

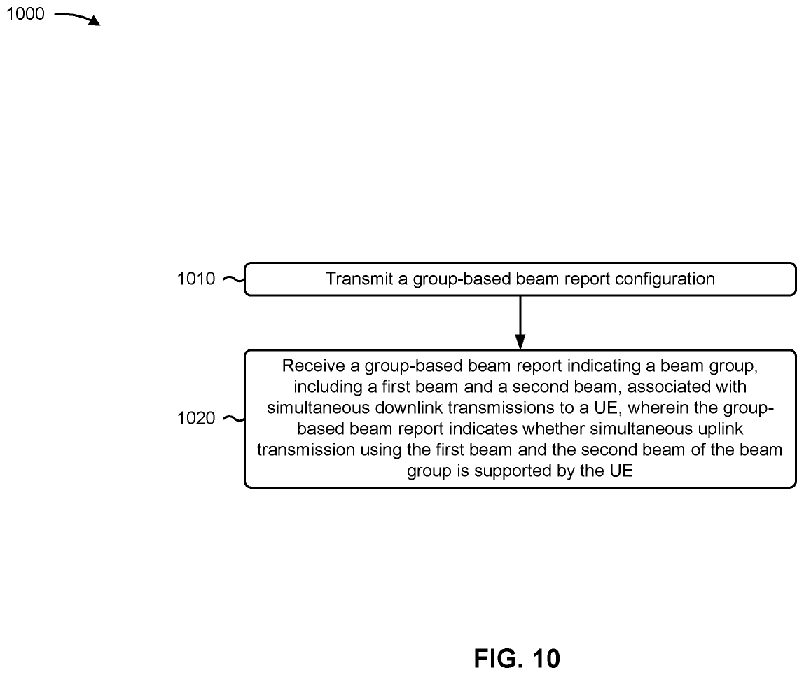

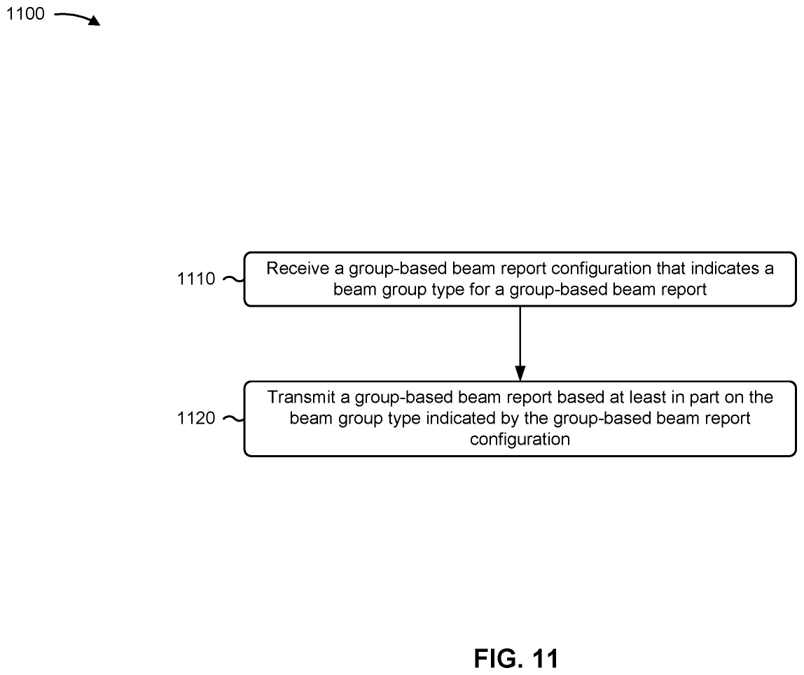

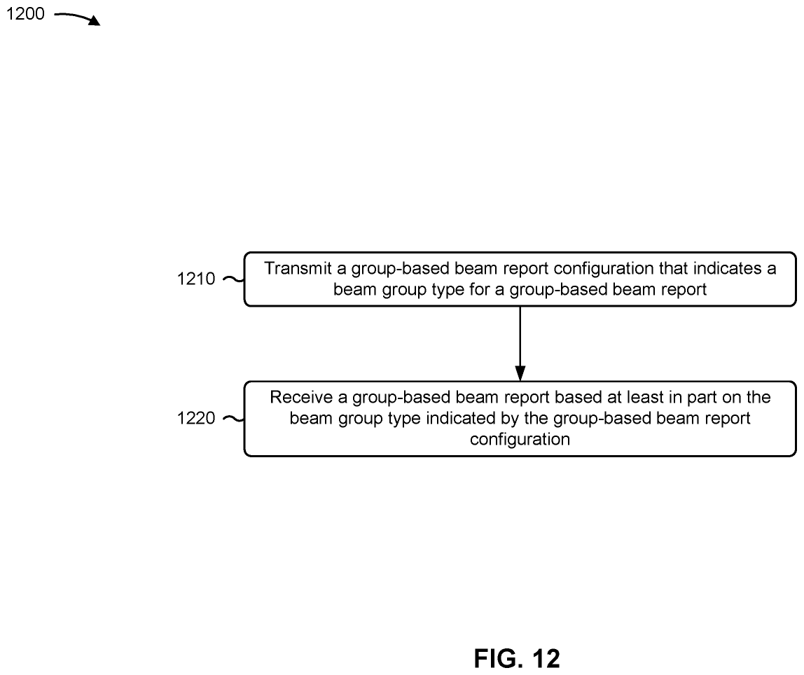

The controller/processor 240 of the base station 110, the controller/processor 280 of the UE 120, and/or any other component(s) of FIG. 2 may perform one or more techniques associated with simultaneous uplink transmission for multiple transmit TRPs, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, process 1100 of FIG. 11, process 1200 of FIG. 12, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples. In some aspects, the network entity described herein is the base station 110, is included in the base station 110, or includes one or more components of the base station 110 shown in FIG. 2. In some aspects, the TRP described herein is the base station 110, is included in the base station 110, or includes one or more components of the base station 110 shown in FIG. 2.

In some aspects, the UE 120 includes means for receiving, from a network entity, a group-based beam report configuration; and/or means for transmitting, to the network entity, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for receiving, from a network entity, a group-based beam report configuration that indicates a beam group type for a group-based beam report; and/or means for transmitting, to the network entity, the group-based beam report based at least in part on the beam group type indicated by the group-based beam report configuration. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity includes means for transmitting, to a UE, a group-based beam report configuration; and/or means for receiving, from the UE, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a network entity includes means for transmitting, to a UE, a group-based beam report configuration that indicates a beam group type for a group-based beam report; and/or means for receiving, from the UE, the group-based beam report based at least in part on the beam group type indicated by the group-based beam report configuration. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units (e.g., a virtual central unit (VCU), a virtual distributed unit (VDU), or a virtual radio unit (VRU)).

Base-station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 3 is a diagram illustrating an example disaggregated base station 300 architecture, in accordance with the present disclosure. The disaggregated base station 300 architecture may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit—User Plane (CU-UP)), control plane functionality (i.e., Central Unit—Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the El interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with respect to FIG. 3.

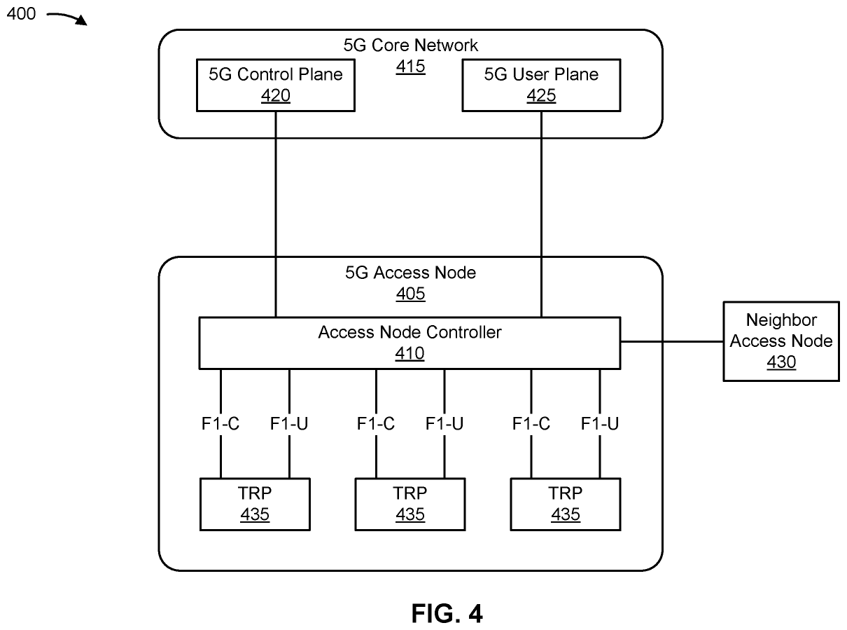

FIG. 4 is a diagram illustrating an example logical architecture of a distributed RAN 400, in accordance with the present disclosure.

A 5G access node 405 may include an access node controller 410. The access node controller 410 may be a CU of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may be a DU of the distributed RAN 400. In some aspects, a TRP 435 may correspond to a base station 110 described above in connection with FIG. 1 and/or a disaggregated base station described above in connection with FIG. 3. For example, different TRPs 435 may be included in different base stations 110. Additionally, or alternatively, multiple TRPs 435 may be included in a single base station 110. In some aspects, a base station 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400. For example, a PDCP layer, an RLC layer, and/or a MAC layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different quasi co-location (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

As indicated above, FIG. 4 is provided as an example. Other examples may differ from what was described with regard to FIG. 4.

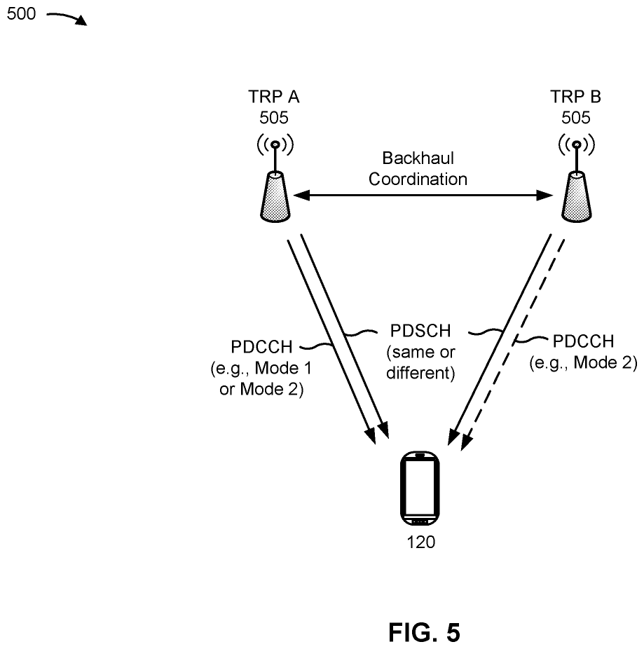

FIG. 5 is a diagram illustrating an example 500 of multiple TRP (multi-TRP) communication (sometimes referred to as multi-panel communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same base station 110 (e.g., when the TRPs 505 are different antenna arrays or panels of the same base station 110), and may have a larger delay and/or lower capacity (as compared to co-location) when the TRPs 505 are located at different base stations 110. The different TRPs 505 may communicate with the UE 120 using different QCL relationships (e.g., different TCI states), different DMRS ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 5 is provided as an example. Other examples may differ from what is described with respect to FIG. 5.

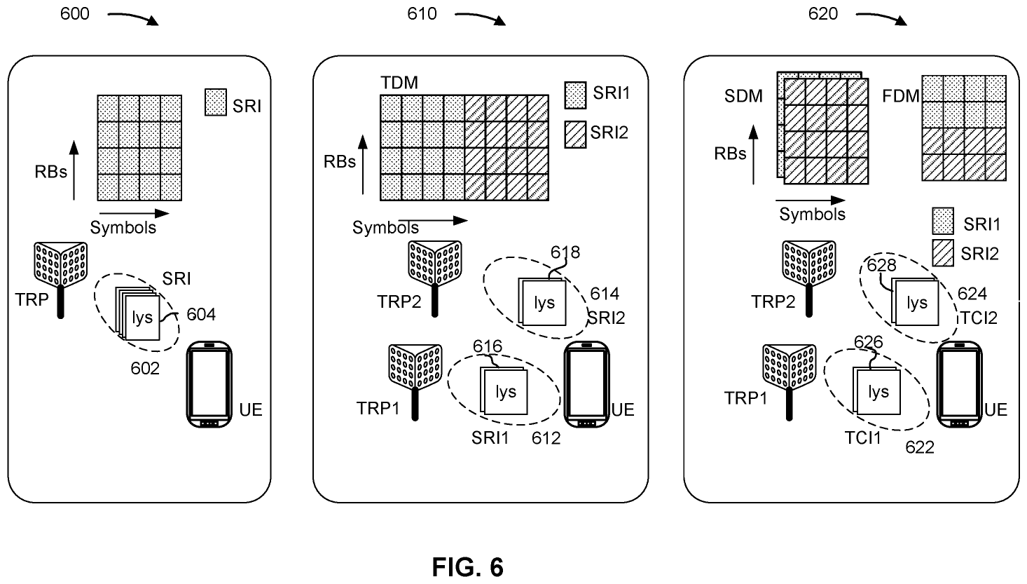

FIG. 6 is a diagram illustrating examples 600, 610, and 620 of uplink transmissions for single TRP communication and multi-TRP communication, in accordance with the present disclosure.

Example 600 shows an example of an uplink transmission for single TRP communication. As shown in example 600, a UE may transmit an uplink transmission to a TRP using an uplink beam 602 (e.g., a UE transmit (Tx) beam). In some examples, the uplink beam 602 may correspond to sounding reference signal (SRS) resource indicator (SRI). In some examples, the UE may use one or more spatial layers 604 for the uplink transmission.

Example 610 shows a first example of uplink transmissions for multi-TRP communication. Example 610 includes a UE, a first TRP (TRP1), and a second TRP (TRP2). As shown in example 610, in some cases, time division multiplexing (TDM) may be used for uplink communications from a UE to the TRPs. For example, uplink transmissions from the UE to TRP1 on a first beam 612 may be time-division-multiplexed with uplink transmissions from the UE to TRP2 on a second beam 614. For example, resources (e.g., resource blocks (RBs)) for uplink transmissions to TRP1 may be allocated at a first time (e.g., a first set of symbols), and resources (e.g., RBs) for uplink transmissions to TRP2 may be allocated at a second time (e.g., a second set of symbols). In some examples, the first beam 612 may correspond to a first SRI (SRI1), and the second beam 614 may correspond to a second SRI (SRI2). The UE may use one or more spatial layers 616 for uplink transmissions on the first beam 612 to TRP1, and the UE may use one or more spatial layers 618 for uplink transmissions on the second beam 614 to TRP2.

Example 620 shows a second example of uplink transmissions for multi-TRP communication. Example 620 includes a UE, a first TRP (TRP1), and a second TRP (TRP2). As shown in example 620, in some aspects, simultaneous uplink transmissions from UE to TRP1 and TRP2 may be supported. In some aspects, the UE may simultaneously transmit uplink transmissions to TRP1 on a first beam 622 and to TRP2 on a second beam 624 using spatial division multiplexing (SDM) or frequency division multiplexing (FDM). In some examples, the first beam 622 may correspond to a first TCI state (TCI1), and the second beam 624 may correspond to a second TCI state (TCI2). The UE may use one or more spatial layers 626 for uplink transmissions on the first beam 622 to TRP1, and the UE may use one or more spatial layers 628 for uplink transmissions on the second beam 624 to TRP2.

As indicated above, FIG. 6 is provided as an example. Other examples may differ from what is described with respect to FIG. 6.

In some examples, a UE may be configured with downlink group-based beam reporting for multi-TRP communication. Beam reporting is one of the CSI reportings which is applied for the UE to report beam-related information. In this case, the UE may report in a group-based beam report, to a base station or TRP, two receive (Rx) beams of the UE that correspond to two Tx beams (e.g., for two TRPs) that can be used for simultaneous transmissions of downlink (e.g., PDCCH and/or PDSCH) communications to the UE. For example, in a case in which the UE is configured with the higher layer parameter groupBasedBeamReporting set to ‘enabled,’ the UE may report, in a single reporting instance, two different CSI-RS resource indicators (CRIs) or SSB resource indicators (SSBRIs) in each beam group for each report setting. The two CRIs or SSBRIs may indicate CSI-RS and/or SSB resources that can be received simultaneously by the UE, and thus may identify beams that can be used for simultaneous downlink transmissions to the UE (e.g., from two TRPs). In some examples, the indicated CSI-RS and/or SSB resources may be received simultaneously by the UE with a single spatial domain receive filter or with multiple simultaneous spatial domain receive filters. That is, when the TRPs simultaneously transmit downlink communications on the beams identified by the indicated CRIs or SSBRIs, the UE may use one beam to receive the downlink communications (e.g., with a single spatial domain receive filter) from two TRPs, or the UE may use the two beams to receive the downlink communications (e.g., with multiple simultaneous spatial domain receive filters) from two TRPs respectively.

In some aspects, simultaneous uplink transmission from a UE to multiple TRPs may be supported. In this case, a UE may transmit an uplink communication simultaneously on two beams. In some aspects, a base station/TRP may determine uplink beams that can used by the UE based on the downlink group-based beam reporting in accordance with channel reciprocity. However, in this case, there may be ambiguity as to whether simultaneous uplink transmission on the uplink beams is supported at the UE. This may result in confusion as to whether uplink transmissions from the UE will be simultaneously transmitted to multiple TRPs or not, which may reduce reliability of the uplink transmissions.

Some techniques and apparatuses described herein enable a UE to receive, from a network entity, a group-based beam report configuration, and to transmit, to the network entity, a group-based beam report indicating a beam group including a first beam and a second beam that are associated with simultaneous downlink transmissions to the UE. The group-based beam report may indicate whether simultaneous uplink transmission using the first beam and the second beam of the beam group is supported by the UE. As a result, ambiguity or confusion, between the UE and the network entity, as to whether simultaneous uplink transmission using the first beam and the second beam is supported may be reduced or eliminated, which may increase reliability of uplink transmissions by the UE.

Some techniques and apparatuses described herein enable a UE to receive, from a network entity, a group-based beam report configuration that indicates a beam group type for a group-based beam report. For example, the beam group type may indicate whether the group-based beam report is to indicate a beam group for which simultaneous uplink transmission on multiple beams is supported by the UE. The UE may transmit, to the network entity, a group-based beam report based at least in part on the beam group type indicated by the group-based beam report configuration. As a result, ambiguity or confusion, between the UE and the network entity, as to whether simultaneous uplink transmission using a beam group indicated in the group-based beam report may be reduced or eliminated, which may increase reliability of uplink transmissions by the UE.

FIG. 7 is a diagram illustrating an example 700 associated with indication of simultaneous uplink transmission for multiple TRPs, in accordance with the present disclosure. As shown in FIG. 7, example 700 includes a first TRP 705-1, a second TRP 705-2, and a UE 120. In some aspects, the TRPs 705 and the UE 120 may be included in a wireless network, such as wireless network 100. The TRPs 705 and the UE 120 may communicate via a wireless access link, which may include an uplink and a downlink. In some aspects, the first TRP 705-1 may be a first network entity (e.g., base station 110, CU 310, DU 330, RU 340, or a combination thereof), and the second TRP 705-2 may be a second network entity (e.g., base station 110, CU 310, DU 330, RU 340, or a combination thereof). In some aspects, the first TRP 705-1 and the second TRP 705-2 may be included in a network entity (e.g., base station 110, CU 310, DU 330, RU 340, or a combination thereof).

As shown in FIG. 7, and by reference number 710, in some aspects, the UE 120 may transmit, to a TRP 705 (e.g., the first TRP 705-1) UE capability information associated with the UE 120. The TRP 705 (e.g., the first TRP 705-1) may receive the UE capability information transmitted by the UE 120. The UE capability information may include information relating to uplink transmission capabilities of the UE 120. In some aspects, the UE capability information may indicate one or more uplink rank capabilities supported by the UE 120. For example, the UE 120 capability information may include a first uplink rank capability and/or a second uplink rank capability. “Uplink rank” refers to a number of spatial layers for an uplink transmission. The first uplink rank capability may be a maximum uplink rank per beam (e.g., maximum uplink rank per antenna channel) for simultaneous uplink transmissions on different beams (e.g., using different antenna panels). The second uplink rank capability may be a maximum total uplink rank across all beams (e.g., across all antenna panels) for uplink transmissions. For example, the UE capability information may include any of MIMO capability, such as the maximum number of SRS ports, the supported coherence type (e.g., full coherence, partial coherence, or non-coherence) for codebook based MIMO transmission, the maximum of MIMO rank, and the panel ID. The UE may indicate multiple sets of UE capabilities, where each set may have a different UE capability set ID.

As further shown in FIG. 7, and by reference number 715, a TRP 705 (e.g., the first TRP 705-1) may transmit, to the UE 120, a group-based beam report configuration. The group-based beam report configuration may be configured as a CSI report configuration. The UE 120 may receive the group-based beam report configuration transmitted by the TRP 705 (e.g., the first TRP 705-1). For example, the TRP 705 (e.g., the first TRP 705-1) may transmit the group-based beam report configuration to the UE 120 and enables (by activating or triggering) the group-based beam report via an RRC message, a MAC control element (MAC-CE), or DCI. In some aspects, as shown in FIG. 7, the first TRP 705-1 may transmit the group-based beam report configuration to UE 120. In some aspects, the second TRP 705-2 may transmit the group-based beam report configuration to the UE 120. In some aspects, both the first TRP 705-1 and the second TRP 705-2 may transmit the group-based beam report configuration to the UE 120.

In some aspects, the group-based beam report configuration may configure the UE 120 for group-based beam reporting. For example, the group-based beam report configuration may include an indication that group-based beam reporting is enabled for the UE 120 (e.g., the higher layer parameter groupBasedBeamReporting is set to ‘enabled’). The group-based beam report configuration may configure multiple (e.g., two) sets of channel measurement resources for the group-based beam report. In connection with group-based beam reporting being enabled for the UE 120, the UE 120 may be configured to report, for a beam group in a single reporting instance, multiple channel measurement resource indexes (e.g., 2 CRIs or SSBRIs) that correspond to multiple (e.g., 2) beams that can be used (e.g., by first TRP 705-1 and second TRP 705-2) for simultaneous downlink transmissions to the UE 120. For example, the UE 120 may report 1, 2, or 4 beam groups based on the group-based beam reporting, where each beam group has two channel measurement resource indexes selected in the two sets of channel measurement resources respectively. In some aspects, the group-based beam report configuration may indicate a configuration of various parameters to be included, by the UE 120, in a group-based beam report.

As further shown in FIG. 7, and by reference number 720, the UE 120 may transmit, to a TRP 705 (e.g., first TRP 705-1) a group-based beam report. The TRP 705 (e.g., the first TRP 705-1) may receive the group-based beam report transmitted by the UE 120. For example, the UE 120 may transmit the group-based beam report (e.g., in accordance with the group-based beam report configuration) via uplink control information (UCI) or a MAC-CE. The group-based beam report may indicate a beam group (e.g., including multiple beams) associated with simultaneous downlink transmissions to the UE 120. The beam group may include a first beam and a second beam that may be used (e.g., by the first TRP 705-1 and the second TRP 705-2, respectively) for simultaneous downlink transmissions to the UE 120. For example, the group-based beam report may include a first downlink reference signal resource indicator (e.g., a first CRI or SSBRI in a first channel measurement resource set) that indicates the first beam and a second downlink reference signal resource indicator (e.g., a second CRI or SSBRI in a second channel measurement resource set) that indicates the second beam. In some aspects, the group-based beam report may indicate whether simultaneous uplink transmission is supported for the beam group. For example, the group-based beam report may indicate whether simultaneous uplink transmission using the first beam and the second beam of the first beam group is supported by the UE 120.

In some aspects, the group-based beam report may include an explicit indication of whether simultaneous uplink transmission using the first beam group (e.g., using the first beam and the second beam) is supported by the UE 120. For example, the group-based beam report may include an indication (e.g., binary indication), associated with the beam group, that indicates whether simultaneous uplink transmission using the first beam and the second beam of the beam group is supported by the UE 120. In some aspects, the group-based beam report configuration may indicate whether or not the UE 120 supports using simultaneous transmission using different uplink spatial filters for the first beam and the second of the beam group. For example, the group-based beam report may include an indication of a number of uplink spatial filters to be used for uplink transmissions associated with the beam group. In this case, the number of uplink spatial filters may indicate whether simultaneous uplink transmission using the first beam and the second beam of the beam group is supported by the UE 120. For example, an indication of 1 for the number of spatial filters may indicate that simultaneous uplink transmission is not supported for the beam group, and an indication of 2 or the number of spatial filters may indicate that simultaneous uplink transmission is supported for the beam group. In a beam reporting instance, the UE 120 may report whether a beam group can be used for simultaneous uplink transmission or not, and whether the same or different spatial filters is applied for two reported channel measurement resource indexes in a beam group.

In some aspects, the group-based beam report may include an indication of the maximum total uplink rank for the beam group. The maximum total uplink rank for the beam group may be the maximum total uplink rank (e.g., the total number of spatial layers) supported by the UE 120 across the first beam and the second beam of the beam group. In some aspects, the maximum total uplink rank for the beam group may indicate whether simultaneous uplink transmission using the first beam and the second beam of the beam group is supported by the UE 120. For example, the UE 120 may report whether the maximum total uplink rank is one or a value larger than one, where a maximum total uplink rank equal to one may indicate that simultaneous uplink transmission is not supported for the beam group, and a maximum total uplink rank that is greater than one may indicate that simultaneous uplink transmission is supported for the beam group.

In some aspects, the UE 120 may report a UE capability per uplink beam per beam group in a group-based beam report. For example, the UE capability may include any of the MIMO-related capability, such as the maximum number of SRS ports, the maximum number of SRS resources in a SRS resource set configured for codebook or non-codebook based MIMO transmission, the supported coherence type (full coherence, partial coherence, or non-coherence) for codebook based MIMO transmission, the maximum number of uplink rank, and the panel ID. In some aspects, the UE capability may be a panel related UE capability. In some aspects, the UE 120 may support multiple sets of UE capabilities, and the UE 120 may report a UE capability set ID per uplink beam per beam group in a group-based beam report. In some aspects, a uplink beam may correspond to a channel measurement resource index.

In some aspects, when the UE 120 supports two UE capabilities (e.g., the first uplink rank capability and the second uplink rank capability), an indication of a UE capability value in the group-based beam report may provide an implicit indication of whether simultaneous uplink transmission is supported for the beam group. In some aspects, in a case in which the UE capability information includes an indication of a first uplink rank value (e.g., “rank1 ”) for the first uplink rank capability (e.g., the maximum uplink rank per beam) and an indication of a second uplink rank value (e.g., “rank2”) for the second uplink rank capability (e.g., the maximum total uplink rank), the group-based beam report may include an indication of the first rank value (e.g., “rank1”) or the second rank value (e.g., “rank2”), and the indication of rank value (e.g., “rank1”) or the second rank value (e.g., “rank2”) may indicate whether simultaneous uplink transmission using the first beam and the second beam of the beam group is supported by the UE 120. For example, the group-based beam report may include an indication of rank1 to indicate that simultaneous transmission is supported for the beam group, or the group-based beam report may include an indication of rank2 to indicate that simultaneous transmission is not supported for the beam group. For another example, the group-based beam report may include an indication of UE capability set ID 1 to indicate that simultaneous transmission is supported for the beam group, or the group-based beam report may include an indication of UE capability set ID 2 to indicate that simultaneous transmission is not supported for the beam group.

In some aspects, the group-based beam report may include, for a beam group, a first downlink reference signal resource indicator (e.g., a first CRI (CRI1) or a first SSBRI (SSBRI1) in the first channel measurement resource set) that identifies the first beam, a first rank indication associated with the first downlink reference signal resource indicator, a second downlink reference signal resource indicator (e.g., a second CRI (CRI2) or a second SSBRI (SSBRI2) in the second channel measurement resource set) that identifies the second beam, and a second rank indication associated with the second downlink reference signal resource indicator. In this case, the UE 120 may set both the first rank indication and the second rank indication to the value of rank1 to indicate that simultaneous transmission is supported for the beam group, or the UE 120 may set both the first rank indication and the second rank indication to the value of rank2 to indicate that simultaneous transmission is not supported for the beam group. For example, an indication of (CRI1/SSBRI1, rank1, CRI1/SSBRI2, rank1) for a beam group may indicate that simultaneous transmission is supported for the beam group, and an indication of (CRI1/SSBRI1, rank2, CRI1/SSBRI2, rank2) for a beam group may indicate that simultaneous transmission is not supported for the beam group. For another example, an indication of (CRI1/SSBRI1, UE capability set ID1, CRI1/SSBRI2, UE capability set ID1) for a beam group may indicate that simultaneous transmission is supported for the beam group, and an indication of (CRI1/SSBRI1, UE capability set ID2, CRI1/SSBRI2, UE capability set ID2) 2) for a beam group may indicate that simultaneous transmission is not supported for the beam group.

The TRP 705 (e.g., the first TRP 705-1 and/or the second TRP 705-2) may determine whether or not simultaneous uplink transmission is supported by the UE 120 for a beam group based at least in part on the rank value (e.g., rank1 or rank2) indicated in the group-based beam report for the beam group.

In some aspects, the group-based beam report may indicate multiple beam groups associated with simultaneous downlink transmissions to the UE 120. In this case, the group-based beam report may indicate, per beam group, whether simultaneous uplink transmission using the beam group is supported by the UE 120.

As further shown in FIG. 7, and by reference number 725, in some aspects, the UE1 may receive, from the first TRP 705-1 and/or the second TRP 705-2, an indication of a scheduled uplink transmission. For example, the indication of the scheduled uplink transmission may be included in DCI (e.g., in a PDCCH communications). In some aspects, the first TRP 705-1 may transmit the indication of the scheduled uplink transmission to the UE 120. In some aspects, the second TRP 705-2 may transmit the indication of the scheduled uplink transmission to the UE 120. In some aspects, the first TRP 705-1 and the second TRP 705-2 may simultaneously transmit the indication of the scheduled uplink transmission to the UE 120.

In some aspects, in connection with the group-based beam report indicating that simultaneous uplink transmission using the first beam and the second beam of the beam group is supported by the UE 120, the first TRP 705-1 and/or the second TRP 705-2 may transmit, to the UE 120, an indication of a scheduled uplink transmission to be simultaneously transmitted by the UE 120 using the first beam and the second beam.

As further shown in FIG. 7, and by reference number 730, in some aspects, the UE 120 may transmit the scheduled uplink transmission in accordance with the indication of the scheduled uplink transmission. In some aspects, in a case in which the group-based beam report indicates that simultaneous uplink transmission using the first beam and the second beam of a beam pair is supported by the UE 120, the UE 120 may simultaneously transmit the scheduled uplink transmission on the first beam of the beam group and the second beam of the beam group. For example, the UE 120 may simultaneously transmit the uplink transmission to the first TRP 705-1 using the first beam and the second TRP 705-2 using the second beam.

As described above, the UE 120 may receive, from a network entity (e.g., a TRP 705), a group-based beam report configuration, and to transmit, to the network entity, a group-based beam report indicating a beam group including a first beam and a second beam that are associated with simultaneous downlink transmissions to the UE 120. The group-based beam report may indicate whether simultaneous uplink transmission using the first beam and the second beam of the beam group is supported by the UE 120. As a result, ambiguity or confusion, between the UE 120 and the network entity, as to whether simultaneous uplink transmission using the first beam and the second beam is supported may be reduced or eliminated, which may increase reliability of uplink transmissions by the UE 120.

As indicated above, FIG. 7 is provided as an example. Other examples may differ from what is described with respect to FIG. 7.

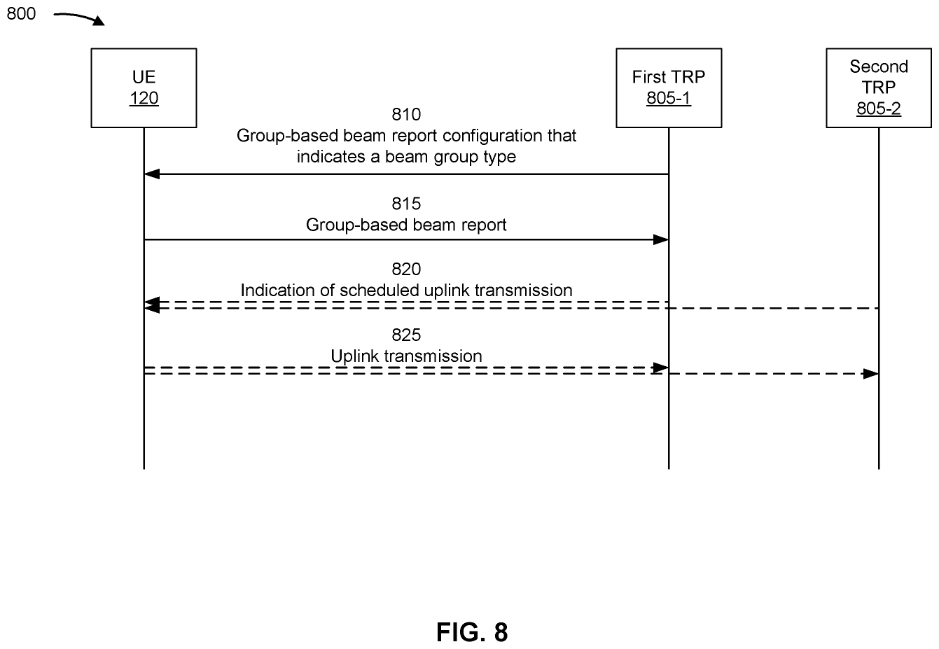

FIG. 8 is a diagram illustrating an example 800 associated with indication of simultaneous uplink transmission for multiple TRPs, in accordance with the present disclosure. As shown in FIG. 8, example 800 includes a first TRP 805-1, a second TRP 805-2, and a UE 120. In some aspects, the TRPs 805 and the UE 120 may be included in a wireless network, such as wireless network 100. The TRPs 805 and the UE 120 may communicate via a wireless access link, which may include an uplink and a downlink. In some aspects, the first TRP 805-1 may be a first network entity (e.g., base station 110, CU 310, DU 330, RU 340, or a combination thereof), and the second TRP 805-2 may be a second network entity (e.g., base station 110, CU 310, DU 330, RU 340, or a combination thereof). In some aspects, the first TRP 805-1 and the second TRP 805-2 may be included in a network entity (e.g., base station 110, CU 310, DU 330, RU 340, or a combination thereof).

As shown in FIG. 8, and by reference number 810, a TRP 805 (e.g., the first TRP 805-1) may transmit, to the UE 120, a group-based beam report configuration that indicates a beam group type for a group-based beam report. The UE 120 may receive the group-based beam report configuration transmitted by the TRP 805 (e.g., the first TRP 805-1). For example, the TRP 805 (e.g., the first TRP 805-1) may transmit the group-based beam report configuration to the UE 120 via an RRC message, a MAC-CE, or DCI. In some aspects, as shown in FIG. 8, the first TRP 805-1 may transmit the group-based beam report configuration to UE 120. In some aspects, the second TRP 805-2 may transmit the group-based beam report configuration to the UE 120. In some aspects, both the first TRP 805-1 and the second TRP 805-2 may transmit the group-based beam report configuration to the UE 120.

In some aspects, the group-based beam report configuration may configure the UE 120 for group-based beam reporting. For example, the group-based beam report configuration may include an indication that group-based beam reporting is enabled for the UE 120 (e.g., the higher layer parameter groupBasedBeamReporting is set to ‘enabled’). In connection with group-based beam reporting being enabled for the UE 120, the UE 120 may be configured to report, for a beam group in a single reporting instance, multiple channel measurement resource indexes (e.g., 2 CRIs or SSBRIs) that correspond to multiple (e.g., 2) beams that can be used (e.g., by first TRP 805-1 and second TRP 805-2) for simultaneous downlink transmissions to the UE 120 and/or simultaneous uplink transmissions from the UE 120. In some aspects, the group-based beam report configuration may indicate a configuration of various parameters to be included, by the UE 120, in a group-based beam report.

The group-based beam report configuration may indicate a beam group type for the group-based beam report. In some aspects, the beam group type may correspond to a purpose of the group-based beam report (e.g., a purpose for the beam group to be indicated in the group-based beam report). For example, beam group type indicated in the group-based beam report configuration may indicate whether the group-based beam report is to indicate a beam group for which simultaneous transmission on multiple beams is supported for the UE 120. For another example, beam group type indicated in the group-based beam report configuration may indicate whether the group-based beam report is to indicate a group of multiple channel measurement resource indexes for which simultaneous transmission is supported for the UE 120. In some aspects, the group-based beam report configuration may indicate a beam group type from a set of beam group types including one or more beam group types that are associated with a beam group to be used for simultaneous uplink transmission (e.g., a beam group for which simultaneous uplink transmissions are supported by the UE 120) and one or more beam group types that are associated with a beam group not used for simultaneous uplink transmissions (e.g., a beam group for which simultaneous uplink transmissions are not supported by the UE 120). In some aspects, the beam group type indicated in the group-based beam report configuration may be a first beam group type associated with a beam group for simultaneous downlink reception, a second beam group type associated with a beam group for simultaneous uplink transmission, or a third beam group type associated with a beam group for simultaneous downlink reception and for simultaneous uplink transmission. In some aspects, the beam group type indicated in the group-based beam report configuration may be a first beam group type specifying that a beam group can be reported only for simultaneous downlink reception at the UE 120, a second beam group type specifying that a beam group can be reported only for simultaneous uplink transmission at the UE 120, or a third beam group type specifying that a beam group can be reported both for simultaneous downlink reception and for simultaneous uplink transmission at the UE 120. The UE 120 can only report beam groups in a beam reporting instance, according to the beam group type indicated in the group-based beam report configuration.

In some aspects, the group-based beam report configuration may indicate a purpose for the channel measurement resource sets associated with the group-based beam report. The group-based beam report configuration may indicate multiple sets of channel measurement resource sets associated with the group-based beam report, and the purpose of the multiple sets of channel measurement resource sets. In some aspects, the purpose of multiple sets of channel measurement resource sets indicated in the group-based beam report configuration may be a first purpose that the multiple sets of channel measurement resource sets are only measured for simultaneous downlink reception at the UE 120, a second purpose that the multiple sets of channel measurement resource sets are only measured for simultaneous uplink transmission at the UE 120, or a third purpose the multiple sets of channel measurement resource sets are measured both for simultaneous downlink reception and for simultaneous uplink transmission at the UE 120. For the third purpose, the UE 120 may be indicated in the group-based beam report configuration that the multiple sets of channel measurement resource sets configured for simultaneous downlink reception can be also reused for simultaneous uplink transmission at the UE 120. The UE 120 can only measure the multiple sets of channel measurement resources in a beam reporting instance, according to the purpose indicated in the group-based beam report configuration.

In some aspects, the group-based beam report configuration may further indicate an intended number of UE beams to be indicated in the group-based beam report. In some aspects, the group-based beam report configuration may indicate a maximum uplink rank per channel measurement index for a beam group to be indicated in the group-based beam report. The group-based beam report configuration may indicate a maximum uplink rank per beam for a beam group to be indicated in the group-based beam report. For example, the group-based beam report configuration may indicate that the maximum uplink rank per beam is 1 or a value greater than 1 for a beam group to be indicated in the group-based beam report. In some aspects, the indicated value for maximum uplink rank per beam may indicate the intended number of UE beams for the beam group. In some aspects, the group-based beam report configuration may indicate a maximum total uplink rank for a beam group to be indicated in the group-based beam report. For example, the group-based beam report configuration may indicate that the maximum total uplink rank (e.g., across all the beams in the beam group) is 1 or a value greater than 1 for a beam group to be indicated in the group-based beam report. In some aspects, the indicated value for maximum uplink rank per beam may indicate the intended number of UE beams for the beam group.

As further shown in FIG. 8, and by reference number 815, the UE 120 may transmit, to a TRP 805 (e.g., first TRP 805-1) a group-based beam report based at least in part on the beam group type indicated by the group-based beam report configuration. The TRP 805 (e.g., the first TRP 805-1) may receive the group-based beam report transmitted by the UE 120. For example, the UE 120 may transmit the group-based beam report (e.g., in accordance with the group-based beam report configuration) via UCI or a MAC-CE.

In some aspects, the group-based beam report may indicate one or more beam groups that satisfy the beam group type indicated by the group-based beam report configuration. For example, the group-based beam report configuration may indicate (e.g., request) a beam group type, and the UE 120 may determine whether any beam groups for the UE 120 satisfy the indicated beam group type. The UE 120, in connection with determining that one or more beam groups satisfy the indicated beam group type, may transmit the group-based beam report indicating the one or more beam groups that satisfy the indicated beam group type. For example, in a case in which the group-based beam report configuration indicates a beam group type associated with simultaneous uplink transmission on multiple beams, the UE 120 may indicate, in the group-based beam report, one or more beam groups for which simultaneous uplink transmission is supported by the UE 120.

In some aspects, in a case in which the group-based beam report configuration indicates an intended number of UE beams for the group-based beam report, the group-based beam report may indicate one or more beam groups that satisfy the beam group type and the intended number UE beams indicated by the group-based beam report configuration. In some aspects, in a case in which the group-based beam report configuration indicates the uplink maximum rank per beam for a beam group to be indicated in the group-based beam report, the group-based beam report may indicate one or more beam groups that satisfy the beam group type and the maximum uplink rank per beam indicated by the group-based beam report configuration. In some aspects, in a case in which the group-based beam report configuration indicates the maximum total uplink rank for a beam group to be indicated in the group-based beam report, the group-based beam report may indicate one or more beam groups that satisfy the beam group type and the maximum total uplink rank indicated by the group-based beam report configuration.

The group-based beam report may include one or more downlink reference signal indicators (e.g., CRIs or SSBRIs) that indicate a beam group (e.g., a beam group that satisfies the beam group type indicated in the group-based beam report configuration). For example, the group-based beam report may include a first downlink reference signal resource indicator (e.g., a first CRI or SSBRI) that indicates the first beam and a second downlink reference signal resource indicator (e.g., a second CRI or SSBRI) that indicates the second beam.

In some aspects, the UE 120 may determine that there are not multiple channel resource indexes in a beam group associated with the UE 120 that satisfy the indicated beam group type and/or other parameters (e.g., the intended number of UE beams, the maximum uplink rank per beam, and/or the maximum total uplink rank) indicated in the group-based beam report configuration. In this case, the group-based beam report may indicate that no corresponding beam group for the group-based beam report configuration has been found by the UE 120. For example, the group-based beam report may include an indication of no beam group based at least in part on the beam group type (and/or other parameters) indicated by the group-based beam report configuration. In some aspects, a metric field (e.g., a reserved metric field) in the group-based beam report may be used to provide the no beam group indication. For example, the indication of no beam group may be an indication of a minimum reportable value in a metric field (e.g., an RSRP field) of the group-based beam report.

As further shown in FIG. 8, and by reference number 820, in some aspects, the UE1 may receive, from the first TRP 805-1 and/or the second TRP 805-2, an indication of a scheduled uplink transmission. For example, the indication of the scheduled uplink transmission may be included in DCI (e.g., in a PDCCH communications). In some aspects, the first TRP 805-1 may transmit the indication of the scheduled uplink transmission to the UE 120. In some aspects, the second TRP 805-2 may transmit the indication of the scheduled uplink transmission to the UE 120. In some aspects, the first TRP 805-1 and the second TRP 805-2 may simultaneously transmit the indication of the scheduled uplink transmission to the UE 120.

In some aspects, in connection with the group-based beam report indicating a beam group, including a first beam and a second beam, that satisfies a beam group type associated with simultaneous uplink transmission, the first TRP 805-1 and/or the second TRP 805-2 may transmit, to the UE 120, an indication of a scheduled uplink transmission to be simultaneously transmitted by the UE 120 using the first beam and the second beam.

As further shown in FIG. 8, and by reference number 825, in some aspects, the UE 120 may transmit the scheduled uplink transmission in accordance with the indication of the scheduled uplink transmission. In some aspects, in a case in which the group-based beam report indicates a beam group, including a first beam and a second beam, that satisfies a beam group type associated with simultaneous uplink transmission, the UE 120 may simultaneously transmit the scheduled uplink transmission on the first beam and the second beam. For example, the UE 120 may simultaneously transmit the uplink transmission to the first TRP 805-1 using the first beam and the second TRP 805-2 using the second beam.

As described above, the UE 120 may receive, from a network entity (e.g., a TRP 805), a group-based beam report configuration that indicates a beam group type for a group-based beam report. For example, the beam group type may indicate whether the group-based beam report is to indicate a beam group for which simultaneous uplink transmission on multiple beams is supported by the UE 120. The UE 120 may transmit, to the network entity, a group-based beam report based at least in part on the beam group type indicated by the group-based beam report configuration. As a result, ambiguity or confusion, between the UE 120 and the network entity, as to whether simultaneous uplink transmission using a beam group indicated in the group-based beam report may be reduced or eliminated, which may increase reliability of uplink transmissions by the UE 120.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with indication of simultaneous uplink transmission for multiple TRPs.

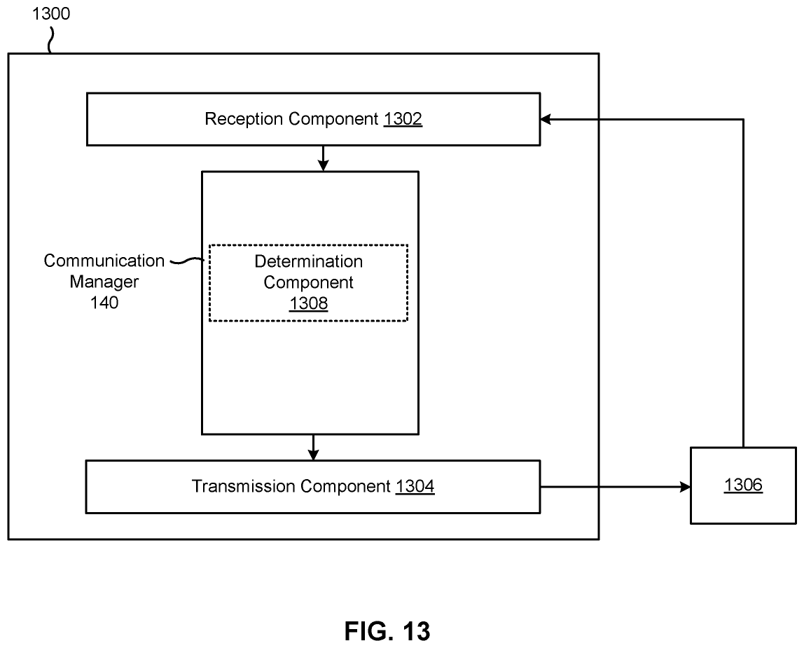

As shown in FIG. 9, in some aspects, process 900 may include receiving, from a network entity, a group-based beam report configuration (block 910). For example, the UE (e.g., using communication manager 140 and/or reception component 1302, depicted in FIG. 13) may receive, from a network entity, a group-based beam report configuration, as described above.

As further shown in FIG. 9, in some aspects, process 900 may include transmitting, to the network entity, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE (block 920). For example, the UE (e.g., using communication manager 140 and/or transmission component 1304, depicted in FIG. 13) may transmit, to the network entity, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE, as described above.

Process 900 may include additional aspects, such as any single aspect or any combination of aspects described below and/or in connection with one or more other processes described elsewhere herein.

In a first aspect, the group-based beam report includes a binary indication, associated with the beam group, that indicates whether simultaneous uplink transmission using the first beam and the second beam of the beam group is supported by the UE.

In a second aspect, alone or in combination with the first aspect, the group-based beam report includes an indication of a number of uplink spatial filters to be used for uplink transmissions associated with the beam group, and the number of uplink spatial filters indicates whether simultaneous uplink transmission using the first beam and the second beam of the beam group is supported by the UE.

In a third aspect, alone or in combination with one or more of the first and second aspects, the group-based beam report includes an indication of a maximum total uplink rank for the beam group.

In a fourth aspect, alone or in combination with one or more of the first through third aspects, the maximum total uplink rank for the beam group indicates whether simultaneous uplink transmission using the first beam and the second beam of the beam group is supported by the UE.

In a fifth aspect, alone or in combination with one or more of the first through fourth aspects, the group-based beam report includes an indication of a first rank value associated with a first capability of the UE or a second rank value associated with a second capability of the UE, and the indication of the first rank value or the second rank value indicates whether simultaneous uplink transmission using the first beam and the second beam of the beam group is supported by the UE.

In a sixth aspect, alone or in combination with one or more of the first through fifth aspects, the first rank value is a maximum uplink rank per beam, and the second rank value is a maximum total uplink rank.

In a seventh aspect, alone or in combination with one or more of the first through sixth aspects, process 900 includes transmitting, to the network entity, UE capability information including the first rank value and the second rank value.

In an eighth aspect, alone or in combination with one or more of the first through seventh aspects, the group-based beam report includes a first downlink reference signal resource indicator that identifies the first beam, a first indication of the first rank value or the second rank value associated with the first downlink reference signal resource indicator, a second downlink reference signal resource indicator that identifies the second beam, and a second indication of the first rank value or the second rank value associated with the second downlink reference signal resource indicator.

In a ninth aspect, alone or in combination with one or more of the first through eighth aspects, process 900 includes receiving, in connection with the group-based beam report indicating that simultaneous uplink transmission using the first beam and the second beam of the beam group is supported by the UE, an indication of a scheduled uplink transmission to be simultaneously transmitted by the UE using the first beam and the second beam, and simultaneously transmitting the scheduled uplink transmission using the first beam and the second beam.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network entity, in accordance with the present disclosure. Example process 1000 is an example where the network entity (e.g., TRP 705, base station 110, CU 310, DU 330, RU 340, or a combination thereof) performs operations associated with indication of simultaneous uplink transmission for multiple TRPs.

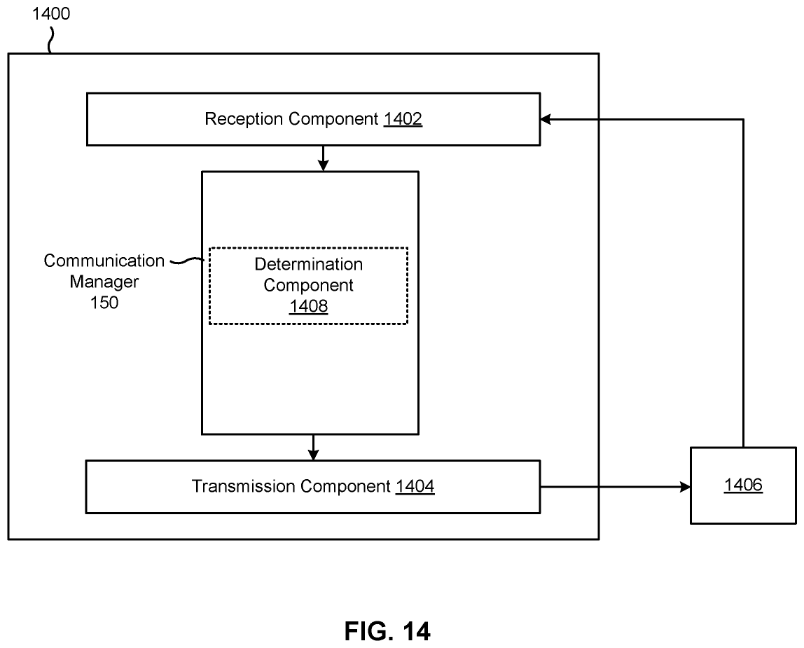

As shown in FIG. 10, in some aspects, process 1000 may include transmitting, to a UE, a group-based beam report configuration (block 1010). For example, the network entity (e.g., using communication manager 150 and/or transmission component 1404, depicted in FIG. 14) may transmit, to a UE, a group-based beam report configuration, as described above.

As further shown in FIG. 10, in some aspects, process 1000 may include receiving, from the UE, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE (block 1020). For example, the network entity (e.g., using communication manager 150 and/or reception component 1402, depicted in FIG. 14) may receive, from the UE, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE, as described above.

Process 1000 may include additional aspects, such as any single aspect or any combination of aspects described below and/or in connection with one or more other processes described elsewhere herein.

In a first aspect, the group-based beam report includes a binary indication, associated with the beam group, that indicates whether simultaneous uplink transmission using the first beam and the second beam of the beam group is supported by the UE.

In a second aspect, the group-based beam report includes an indication of a number of uplink spatial filters to be used for uplink transmissions associated with the beam group, and the number of uplink spatial filters indicates whether simultaneous uplink transmission using the first beam and the second beam of the beam group is supported by the UE.

In a third aspect, the group-based beam report includes an indication of a maximum total uplink rank for the beam group.

In a fourth aspect, the maximum total uplink rank for the beam group indicates whether simultaneous uplink transmission using the first beam and the second beam of the beam group is supported by the UE.

In a fifth aspect, the group-based beam report includes an indication of a first rank value associated with a first capability of the UE or a second rank value associated with a second capability of the UE, and the indication of the first rank value or the second rank value indicates whether simultaneous uplink transmission using the first beam and the second beam of the beam group is supported by the UE.

In a sixth aspect, the first rank value is a maximum uplink rank per beam, and the second rank value is a maximum is a maximum total uplink rank.

In a seventh aspect, process 1000 includes receiving, from the UE, UE capability information including the first rank value and the second rank value.

In an eighth aspect, the group-based beam report includes a first downlink reference signal resource indicator that identifies the first beam, a first indication of the first rank value or the second rank value associated with the first downlink reference signal resource indicator, a second downlink reference signal resource indicator that identifies the second beam, and a second indication of the first rank value or the second rank value associated with the second downlink reference signal resource indicator.

In a ninth aspect, process 1000 includes transmitting, to the UE and in connection with the group-based beam report indicating that simultaneous uplink transmission using the first beam and the second beam of the beam group is supported by the UE, an indication of a scheduled uplink transmission to be simultaneously transmitted by the UE using the first beam and the second beam.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120) performs operations associated with indication of simultaneous uplink transmission for TRPs.

As shown in FIG. 11, in some aspects, process 1100 may include receiving, from a network entity, a group-based beam report configuration that indicates a beam group type for a group-based beam report (block 1110). For example, the UE (e.g., using communication manager 140 and/or reception component 1302, depicted in FIG. 13) may receive, from a network entity, a group-based beam report configuration that indicates a beam group type for a group-based beam report, as described above.

As further shown in FIG. 11, in some aspects, process 1100 may include transmitting, to the network entity, the group-based beam report based at least in part on the beam group type indicated by the group-based beam report configuration (block 1120). For example, the UE (e.g., using communication manager 140 and/or transmission component 1304, depicted in FIG. 13) may transmit, to the network entity, the group-based beam report based at least in part on the beam group type indicated by the group-based beam report configuration, as described above.

Process 1100 may include additional aspects, such as any single aspect or any combination of aspects described below and/or in connection with one or more other processes described elsewhere herein.

In a first aspect, the beam group type indicates whether the group-based beam report is to indicate a beam group for which simultaneous transmission on multiple beams is supported for the UE.

In a second aspect, the beam group type is one of a first beam group type associated with a beam group for simultaneous downlink reception, a second beam group type associated with a beam group for simultaneous uplink transmission, or a third beam group type associated with a beam group for simultaneous downlink reception and for simultaneous uplink transmission.

In a third aspect, the group-based beam report indicates one or more beam groups satisfying the beam group type indicated by the group-based beam report configuration.

In a fourth aspect, the group-based beam report configuration indicates a maximum rank per beam for a beam group to be indicated in the group-based beam report.

In a fifth aspect, the group-based beam report indicates one or more beam groups satisfying the beam group type and the maximum rank per beam indicated by the group-based beam report configuration.

In a sixth aspect, the group-based beam report configuration indicates a maximum total uplink rank for a beam group to be indicated in the group-based beam report.

In a seventh aspect, the group-based beam report indicates one or more beam groups satisfying the beam group type and the maximum total uplink rank indicated by the group-based beam report configuration.

In an eighth aspect, the group-based beam report includes an indication of no beam group based at least in part on the beam group type indicated by the group-based beam report configuration.

In a ninth aspect, the indication of no beam group is an indication of a minimum reportable value in a metric field of the group-based beam report.

In a tenth aspect, the indication of no beam group is an indication of a minimum reportable value in an RSRP field of the group-based beam report.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network entity, in accordance with the present disclosure. Example process 1200 is an example where the network entity (e.g., TRP 805, base station 110, CU 310, DU 330, RU 340, or a combination thereof) performs operations associated with indication of simultaneous uplink transmission for multiple TRPs.

As shown in FIG. 12, in some aspects, process 1200 may include transmitting, to a UE, a group-based beam report configuration that indicates a beam group type for a group-based beam report (block 1210). For example, the network entity (e.g., using communication manager 150 and/or transmission component 1404, depicted in FIG. 14) may transmit, to a UE, a group-based beam report configuration that indicates a beam group type for a group-based beam report, as described above.

As further shown in FIG. 12, in some aspects, process 1200 may include receiving, from the UE, the group-based beam report based at least in part on the beam group type indicated by the group-based beam report configuration (block 1220). For example, the network entity (e.g., using communication manager 150 and/or reception component 1402, depicted in FIG. 14) may receive, from the UE, the group-based beam report based at least in part on the beam group type indicated by the group-based beam report configuration, as described above.

Process 1200 may include additional aspects, such as any single aspect or any combination of aspects described below and/or in connection with one or more other processes described elsewhere herein.

In a first aspect, the beam group type indicates whether the group-based beam report is to indicate a beam group for which simultaneous transmission on multiple beams is supported for the UE.

In a second aspect, the beam group type is one of a first beam group type associated with a beam group for simultaneous downlink reception, a second beam group type associated with a beam group for simultaneous uplink transmission, or a third beam group type associated with a beam group for simultaneous downlink reception and for simultaneous uplink transmission.

In a third aspect, the group-based beam report indicates one or more beam groups satisfying the beam group type indicated by the group-based beam report configuration.

In a fourth aspect, the group-based beam report configuration indicates a maximum rank per beam for a beam group to be indicated in the group-based beam report.

In a fifth aspect, the group-based beam report indicates one or more beam groups satisfying the beam group type and the maximum rank per beam indicated by the group-based beam report configuration.

In a sixth aspect, the group-based beam report configuration indicates a maximum total uplink rank for a beam group to be indicated in the group-based beam report.

In a seventh aspect, the group-based beam report indicates one or more beam groups satisfying the beam group type and the maximum total uplink rank indicated by the group-based beam report configuration.

In an eighth aspect, the group-based beam report includes an indication of no beam group based at least in part on the beam group type indicated by the group-based beam report configuration.

In a ninth aspect, the indication of no beam group is an indication of a minimum reportable value in a metric field of the group-based beam report.

In a tenth aspect, the indication of no beam group is an indication of a minimum reportable value in an RSRP field of the group-based beam report.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include a determination component 1308, among other examples.

In some aspects, the apparatus 1300 may be configured to perform one or more operations described herein in connection with FIGS. 7-8. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The reception component 1302 may receive, from a network entity, a group-based beam report configuration. The transmission component 1304 may transmit, to the network entity, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE.

The transmission component 1304 may transmit, to the network entity, UE capability information including the first rank value and the second rank value.

The reception component 1302 may receive, in connection with the group-based beam report indicating that simultaneous uplink transmission using the first beam and the second beam of the beam group is supported by the UE, an indication of a scheduled uplink transmission to be simultaneously transmitted by the UE using the first beam and the second beam.

The transmission component 1304 may simultaneously transmit the scheduled uplink transmission using the first beam and the second beam.

The reception component 1302 may receive, from a network entity, a group-based beam report configuration that indicates a beam group type for a group-based beam report. The transmission component 1304 may transmit, to the network entity, the group-based beam report based at least in part on the beam group type indicated by the group-based beam report configuration.

The determination component 1308 may determine whether one or more beam groups satisfy the beam group type indicated by the group-based beam report configuration.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a network entity, or a network entity may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 150. The communication manager 150 may include a determination component 1408, among other examples.

In some aspects, the apparatus 1400 may be configured to perform one or more operations described herein in connection with FIGS. 7-8. Additionally, or alternatively, the apparatus 1400 may be configured to perform one or more processes described herein, such as process 1000 of FIG. 10, process 1200 of FIG. 12, or a combination thereof. In some aspects, the apparatus 1400 and/or one or more components shown in FIG. 14 may include one or more components of the network entity described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network entity described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the network entity described in connection with FIG. 2. In some aspects, the transmission component 1404 may be co-located with the reception component 1402 in a transceiver.

The transmission component 1404 may transmit, to a UE, a group-based beam report configuration. The reception component 1402 may receive, from the UE, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE.

The reception component 1402 may receive, from the UE, UE capability information including the first rank value and the second rank value.

The transmission component 1404 may transmit, to the UE and in connection with the group-based beam report indicating that simultaneous uplink transmission using the first beam and the second beam of the beam group is supported by the UE, an indication of a scheduled uplink transmission to be simultaneously transmitted by the UE using the first beam and the second beam.

The transmission component 1404 may transmit, to a UE, a group-based beam report configuration that indicates a beam group type for a group-based beam report. The reception component 1402 may receive, from the UE, the group-based beam report based at least in part on the beam group type indicated by the group-based beam report configuration.

The determination component 1408 may determine the beam group type indicated by the group-based beam report configuration.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: receiving, from a network entity, a group-based beam report configuration; and transmitting, to the network entity, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE.

Aspect 2: The method of Aspect 1, wherein the group-based beam report includes a binary indication, associated with the beam group, that indicates whether simultaneous uplink transmission using the first beam and the second beam of the beam group is supported by the UE.

Aspect 3: The method of any of Aspects 1-2, wherein the group-based beam report includes an indication of a number of uplink spatial filters to be used for uplink transmissions associated with the beam group, wherein the number of uplink spatial filters indicates whether simultaneous uplink transmission using the first beam and the second beam of the beam group is supported by the UE.

Aspect 4: The method of any of Aspects 1-3, wherein the group-based beam report includes an indication of a maximum total uplink rank for the beam group.

Aspect 5: The method of Aspect 4, wherein the maximum total uplink rank for the beam group indicates whether simultaneous uplink transmission using the first beam and the second beam of the beam group is supported by the UE.

Aspect 6: The method of Aspect 1, wherein the group-based beam report includes an indication of a first rank value associated with a first capability of the UE or a second rank value associated with a second capability of the UE, wherein the indication of the first rank value or the second rank value indicates whether simultaneous uplink transmission using the first beam and the second beam of the beam group is supported by the UE.

Aspect 7: The method of Aspect 6, wherein the first rank value is a maximum uplink rank per beam, and wherein the second rank value is a maximum total uplink rank.

Aspect 8: The method of any of Aspects 6-7, further comprising: transmitting, to the network entity, UE capability information including the first rank value and the second rank value.

Aspect 9: The method of any of Aspects 6-8, wherein the group-based beam report includes a first downlink reference signal resource indicator that identifies the first beam, a first indication of the first rank value or the second rank value associated with the first downlink reference signal resource indicator, a second downlink reference signal resource indicator that identifies the second beam, and a second indication of the first rank value or the second rank value associated with the second downlink reference signal resource indicator.

Aspect 10: The method of any of Aspects 1-9, further comprising: receiving, in connection with the group-based beam report indicating that simultaneous uplink transmission using the first beam and the second beam of the beam group is supported by the UE, an indication of a scheduled uplink transmission to be simultaneously transmitted by the UE using the first beam and the second beam; and simultaneously transmitting the scheduled uplink transmission using the first beam and the second beam.

Aspect 11: A method of wireless communication performed by a network entity, comprising: transmitting, to a user equipment (UE), a group-based beam report configuration; and receiving, from the UE, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE.

Aspect 12: The method of Aspect 11, wherein the group-based beam report includes a binary indication, associated with the beam group, that indicates whether simultaneous uplink transmission using the first beam and the second beam of the beam group is supported by the UE.

Aspect 13: The method of any of Aspects 11-12, wherein the group-based beam report includes an indication of a number of uplink spatial filters to be used for uplink transmissions associated with the beam group, wherein the number of uplink spatial filters indicates whether simultaneous uplink transmission using the first beam and the second beam of the beam group is supported by the UE.

Aspect 14: The method of any of Aspects 11-13, wherein the group-based beam report includes an indication of a maximum total uplink rank for the beam group.

Aspect 15: The method of Aspect 14, wherein the maximum total uplink rank for the beam group indicates whether simultaneous uplink transmission using the first beam and the second beam of the beam group is supported by the UE.

Aspect 16: The method of Aspect 11, wherein the group-based beam report includes an indication of a first rank value associated with a first capability of the UE or a second rank value associated with a second capability of the UE, wherein the indication of the first rank value or the second rank value indicates whether simultaneous uplink transmission using the first beam and the second beam of the beam group is supported by the UE.

Aspect 17: The method of Aspect 16, wherein the first rank value is a maximum uplink rank per beam, and wherein the second rank value is a maximum is a maximum total uplink rank.

Aspect 18: The method of any of Aspects 16-17, further comprising: receiving, from the UE, UE capability information including the first rank value and the second rank value.

Aspect 19: The method of any of Aspects 16-18, wherein the group-based beam report includes a first downlink reference signal resource indicator that identifies the first beam, a first indication of the first rank value or the second rank value associated with the first downlink reference signal resource indicator, a second downlink reference signal resource indicator that identifies the second beam, and a second indication of the first rank value or the second rank value associated with the second downlink reference signal resource indicator.

Aspect 20: The method of any of Aspects 11-19, further comprising: transmitting, to the UE and in connection with the group-based beam report indicating that simultaneous uplink transmission using the first beam and the second beam of the beam group is supported by the UE, an indication of a scheduled uplink transmission to be simultaneously transmitted by the UE using the first beam and the second beam.

Aspect 21: A method of wireless communication performed by a user equipment (UE), comprising: receiving, from a network entity, a group-based beam report configuration that indicates a beam group type for a group-based beam report; and transmitting, to the network entity, the group-based beam report based at least in part on the beam group type indicated by the group-based beam report configuration.

Aspect 22: The method of Aspect 21, wherein the beam group type indicates whether the group-based beam report is to indicate a beam group for which simultaneous transmission on multiple beams is supported for the UE.

Aspect 23: The method of any of Aspects 21-22, wherein the beam group type is one of a first beam group type associated with a beam group for simultaneous downlink reception, a second beam group type associated with a beam group for simultaneous uplink transmission, or a third beam group type associated with a beam group for simultaneous downlink reception and for simultaneous uplink transmission.

Aspect 24: The method of any of Aspects 21-23, wherein the group-based beam report indicates one or more beam groups satisfying the beam group type indicated by the group-based beam report configuration.

Aspect 25: The method of any of Aspects 21-24, wherein the group-based beam report configuration indicates a maximum rank per beam for a beam group to be indicated in the group-based beam report.

Aspect 26: The method of Aspect 25, wherein the group-based beam report indicates one or more beam groups satisfying the beam group type and the maximum rank per beam indicated by the group-based beam report configuration.

Aspect 27: The method of any of Aspects 21-26, wherein the group-based beam report configuration indicates a maximum total uplink rank for a beam group to be indicated in the group-based beam report.

Aspect 28: The method of Aspect 27, wherein the group-based beam report indicates one or more beam groups satisfying the beam group type and the maximum total uplink rank indicated by the group-based beam report configuration.

Aspect 29: The method of any of Aspects 21-23, 25, or 27, wherein the group-based beam report includes an indication of no beam group based at least in part on the beam group type indicated by the group-based beam report configuration.

Aspect 30: The method of Aspect 29, wherein the indication of no beam group is an indication of a minimum reportable value in a metric field of the group-based beam report.

Aspect 31: The method of any of Aspects 29-30, wherein the indication of no beam group is an indication of a minimum reportable value in a reference signal received power (RSRP) field of the group-based beam report.

Aspect 32: A method of wireless communication performed by a network entity, comprising: transmitting, to a user equipment (UE), a group-based beam report configuration that indicates a beam group type for a group-based beam report; and receiving, from the UE, the group-based beam report based at least in part on the beam group type indicated by the group-based beam report configuration.

Aspect 33: The method of Aspect 32, wherein the beam group type indicates whether the group-based beam report is to indicate a beam group for which simultaneous transmission on multiple beams is supported for the UE.

Aspect 34: The method of any of Aspects 32-33, wherein the beam group type is one of a first beam group type associated with a beam group for simultaneous downlink reception, a second beam group type associated with a beam group for simultaneous uplink transmission, or a third beam group type associated with a beam group for simultaneous downlink reception and for simultaneous uplink transmission.

Aspect 35: The method of any of Aspects 32-34, wherein the group-based beam report indicates one or more beam groups satisfying the beam group type indicated by the group-based beam report configuration.

Aspect 36: The method of any of Aspects 32-35, wherein the group-based beam report configuration indicates a maximum rank per beam for a beam group to be indicated in the group-based beam report.

Aspect 37: The method of Aspect 36, wherein the group-based beam report indicates one or more beam groups satisfying the beam group type and the maximum rank per beam indicated by the group-based beam report configuration.

Aspect 38: The method of any of Aspects 32-37, wherein the group-based beam report configuration indicates a maximum total uplink rank for a beam group to be indicated in the group-based beam report.

Aspect 39: The method of Aspect 38, wherein the group-based beam report indicates one or more beam groups satisfying the beam group type and the maximum total uplink rank indicated by the group-based beam report configuration.

Aspect 40: The method of any of Aspects 32-34, 36, or 38, wherein the group-based beam report includes an indication of no beam group based at least in part on the beam group type indicated by the group-based beam report configuration.

Aspect 41: The method of Aspect 40, wherein the indication of no beam group is an indication of a minimum reportable value in a metric field of the group-based beam report.

Aspect 42: The method of any of Aspects 40-41, wherein the indication of no beam group is an indication of a minimum reportable value in a reference signal received power (RSRP) field of the group-based beam report.

Aspect 43: An apparatus for wireless communication at a device, comprising a processor; memory coupled with the processor; and instructions stored in the memory and executable by the processor to cause the apparatus to perform the method of one or more of Aspects 1-10.

Aspect 44: A device for wireless communication, comprising a memory and one or more processors coupled to the memory, the one or more processors configured to perform the method of one or more of Aspects 1-10.

Aspect 45: An apparatus for wireless communication, comprising at least one means for performing the method of one or more of Aspects 1-10.

Aspect 46: A non-transitory computer-readable medium storing code for wireless communication, the code comprising instructions executable by a processor to perform the method of one or more of Aspects 1-10.

Aspect 47: A non-transitory computer-readable medium storing a set of instructions for wireless communication, the set of instructions comprising one or more instructions that, when executed by one or more processors of a device, cause the device to perform the method of one or more of Aspects 1-10.

Aspect 48: An apparatus for wireless communication at a device, comprising a processor; memory coupled with the processor; and instructions stored in the memory and executable by the processor to cause the apparatus to perform the method of one or more of Aspects 11-20.

Aspect 49: A device for wireless communication, comprising a memory and one or more processors coupled to the memory, the one or more processors configured to perform the method of one or more of Aspects 11-20.

Aspect 50: An apparatus for wireless communication, comprising at least one means for performing the method of one or more of Aspects 11-20.

Aspect 51: A non-transitory computer-readable medium storing code for wireless communication, the code comprising instructions executable by a processor to perform the method of one or more of Aspects 11-20.

Aspect 52: A non-transitory computer-readable medium storing a set of instructions for wireless communication, the set of instructions comprising one or more instructions that, when executed by one or more processors of a device, cause the device to perform the method of one or more of Aspects 11-20.

Aspect 53: An apparatus for wireless communication at a device, comprising a processor; memory coupled with the processor; and instructions stored in the memory and executable by the processor to cause the apparatus to perform the method of one or more of Aspects 21-31.

Aspect 54: A device for wireless communication, comprising a memory and one or more processors coupled to the memory, the one or more processors configured to perform the method of one or more of Aspects 21-31.

Aspect 55: An apparatus for wireless communication, comprising at least one means for performing the method of one or more of Aspects 21-31.

Aspect 56: A non-transitory computer-readable medium storing code for wireless communication, the code comprising instructions executable by a processor to perform the method of one or more of Aspects 21-31.

Aspect 57: A non-transitory computer-readable medium storing a set of instructions for wireless communication, the set of instructions comprising one or more instructions that, when executed by one or more processors of a device, cause the device to perform the method of one or more of Aspects 21-31.

Aspect 58: An apparatus for wireless communication at a device, comprising a processor; memory coupled with the processor; and instructions stored in the memory and executable by the processor to cause the apparatus to perform the method of one or more of Aspects 32-42.

Aspect 59: A device for wireless communication, comprising a memory and one or more processors coupled to the memory, the one or more processors configured to perform the method of one or more of Aspects 32-42.

Aspect 60: An apparatus for wireless communication, comprising at least one means for performing the method of one or more of Aspects 32-42.

Aspect 61: A non-transitory computer-readable medium storing code for wireless communication, the code comprising instructions executable by a processor to perform the method of one or more of Aspects 32-42.

Aspect 62: A non-transitory computer-readable medium storing a set of instructions for wireless communication, the set of instructions comprising one or more instructions that, when executed by one or more processors of a device, cause the device to perform the method of one or more of Aspects 32-42.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a network entity, a group-based beam report configuration; and
transmit, to the network entity, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE.

2. The UE of claim 1, wherein the group-based beam report includes a binary indication, associated with the beam group, that indicates whether simultaneous uplink transmission using the first beam and the second beam of the beam group is supported by the UE.

3. The UE of claim 1, wherein the group-based beam report includes an indication of a number of uplink spatial filters to be used for uplink transmissions associated with the beam group, wherein the number of uplink spatial filters indicates whether simultaneous uplink transmission using the first beam and the second beam of the beam group is supported by the UE.

4. The UE of claim 1, wherein the group-based beam report includes an indication of a maximum total uplink rank for the beam group.

5. The UE of claim 4, wherein the maximum total uplink rank for the beam group indicates whether simultaneous uplink transmission using the first beam and the second beam of the beam group is supported by the UE.

6. The UE of claim 1, wherein the group-based beam report includes an indication of a first rank value associated with a first capability of the UE or a second rank value associated with a second capability of the UE, wherein the indication of the first rank value or the second rank value indicates whether simultaneous uplink transmission using the first beam and the second beam of the beam group is supported by the UE.

7. The UE of claim 6, wherein the first rank value is a maximum uplink rank per beam, and wherein the second rank value is a maximum total uplink rank.

8. The UE of claim 6, wherein the one or more processors are further configured to:
transmit, to the network entity, UE capability information including the first rank value and the second rank value.

9. The UE of claim 6, wherein the group-based beam report includes a first downlink reference signal resource indicator that identifies the first beam, a first indication of the first rank value or the second rank value associated with the first downlink reference signal resource indicator, a second downlink reference signal resource indicator that identifies the second beam, and a second indication of the first rank value or the second rank value associated with the second downlink reference signal resource indicator.

10. The UE of claim 1, wherein the one or more processors are further configured to:
receive, in connection with the group-based beam report indicating that simultaneous uplink transmission using the first beam and the second beam of the beam group is supported by the UE, an indication of a scheduled uplink transmission to be simultaneously transmitted by the UE using the first beam and the second beam; and
simultaneously transmit the scheduled uplink transmission using the first beam and the second beam.

11. A user equipment (UE) for wireless communication, comprising:
a memory; and
one or more processors, coupled to the memory, configured to:
receive, from a network entity, a group-based beam report configuration that indicates a beam group type for a group-based beam report; and
transmit, to the network entity, the group-based beam report based at least in part on the beam group type indicated by the group-based beam report configuration.

12. The UE of claim 11, wherein the beam group type indicates whether the group-based beam report is to indicate a beam group for which simultaneous transmission on multiple beams is supported for the UE.

13. The UE of claim 11, wherein the beam group type is one of a first beam group type associated with a beam group for simultaneous downlink reception, a second beam group type associated with a beam group for simultaneous uplink transmission, or a third beam group type associated with a beam group for simultaneous downlink reception and for simultaneous uplink transmission.

14. The UE of claim 11, wherein the group-based beam report indicates one or more beam groups satisfying the beam group type indicated by the group-based beam report configuration.

15. The UE of claim 11, wherein the group-based beam report configuration indicates a maximum rank per beam for a beam group to be indicated in the group-based beam report.

16. The UE of claim 15, wherein the group-based beam report indicates one or more beam groups satisfying the beam group type and the maximum rank per beam indicated by the group-based beam report configuration.

17. The UE of claim 11, wherein the group-based beam report configuration indicates a maximum total uplink rank for a beam group to be indicated in the group-based beam report.

18. The UE of claim 17, wherein the group-based beam report indicates one or more beam groups satisfying the beam group type and the maximum total uplink rank indicated by the group-based beam report configuration.

19. The UE of claim 11, wherein the group-based beam report includes an indication of no beam group based at least in part on the beam group type indicated by the group-based beam report configuration.

20. The UE of claim 19, wherein the indication of no beam group is an indication of a minimum reportable value in a metric field of the group-based beam report.

21. The UE of claim 19, wherein the indication of no beam group is an indication of a minimum reportable value in a reference signal received power (RSRP) field of the group-based beam report.

22. A method of wireless communication performed by a user equipment (UE), comprising:
receiving, from a network entity, a group-based beam report configuration; and
transmitting, to the network entity, a group-based beam report indicating a beam group, including a first beam and a second beam, associated with simultaneous downlink transmissions to the UE, wherein the group-based beam report indicates whether simultaneous uplink transmission using the first beam and the second beam of the beam group is supported by the UE.

23. The method of claim 22, wherein the group-based beam report includes a binary indication, associated with the beam group, that indicates whether simultaneous uplink transmission using the first beam and the second beam of the beam group is supported by the UE.

24. The method of claim 22, wherein the group-based beam report includes an indication of a number of uplink spatial filters to be used for uplink transmissions associated with the beam group, wherein the number of uplink spatial filters indicates whether simultaneous uplink transmission using the first beam and the second beam of the beam group is supported by the UE.

25. The method of claim 22, wherein the group-based beam report includes an indication of a maximum total uplink rank for the beam group.

26. The method of claim 22, wherein the group-based beam report includes an indication of a first rank value associated with a first capability of the UE or a second rank value associated with a second capability of the UE, wherein the indication of the first rank value or the second rank value indicates whether simultaneous uplink transmission using the first beam and the second beam of the beam group is supported by the UE.

27. A method of wireless communication performed by a user equipment (UE), comprising:
receiving, from a network entity, a group-based beam report configuration that indicates a beam group type for a group-based beam report; and
transmitting, to the network entity, the group-based beam report based at least in part on the beam group type indicated by the group-based beam report configuration.

28. The method of claim 27, wherein the beam group type indicates whether the group-based beam report is to indicate a beam group for which simultaneous transmission on multiple beams is supported for the UE.

29. The method of claim 27, wherein the group-based beam report indicates one or more beam groups satisfying the beam group type indicated by the group-based beam report configuration.

30. The method of claim 27, wherein the group-based beam report configuration indicates at least one of a maximum rank per beam or a maximum total uplink rank for a beam group to be indicated in the group-based beam report.
